(19) United States
(12) Patent Application Publication
(10) Pub. No.: US 2024/0181399 A1
(43) Pub. Date: Jun. 6, 2024

(54) PROCESSING METHOD OF SEPARATION MEMBRANE COMPLEX AND PROCESSING APPARATUS FOR SEPARATION MEMBRANE COMPLEX

(71) Applicant: NGK INSULATORS, LTD., Nagoya-City (JP)

(72) Inventors: Kenichi NODA, Nagoya-City (JP); Narumi TOMOKAGE, Nagoya-City (JP)

(73) Assignee: NGK INSULATORS, LTD., Nagoya-City (JP)

(21) Appl. No.: 18/438,583

(22) Filed: Feb. 12, 2024

Related U.S. Application Data
(63) Continuation of application No. PCT/JP2022/032052, filed on Aug. 25, 2022.

(30) Foreign Application Priority Data
Sep. 10, 2021 (JP) 2021-147815

(51) Int. Cl. B01D 65/02; B01D 53/22; B01D 71/02

(52) U.S. Cl. CPC B01D 65/02; B01D 53/22; B01D 71/0281; B01D 2321/18; B01D 2321/44

(57) ABSTRACT

A processing method of a separation membrane complex includes a step of preparing a separation membrane complex including a porous support and a separation membrane formed on the support and a step of bringing a cleaning fluid composed of supercritical or subcritical carbon dioxide having a density of 600 to 1000 kg/m³ into contact with the separation membrane of the separation membrane complex.

### CROSS-REFERENCE TO RELATED APPLICATIONS

The present application is a continuation application of International Application No. PCT/JP2022/32052 filed on Aug. 25, 2022, which claims priority to Japanese Patent Application No. 2021-147815 filed on Sep. 10, 2021. The contents of these applications are incorporated herein by reference in their entirety.

### TECHNICAL FIELD

The present invention relates to a technique for processing a separation membrane complex.

### BACKGROUND ART

Conventionally, a zeolite membrane is used as a separation membrane using a molecular sieving function. The zeolite membrane is ordinarily formed on a porous support and handled as a separation membrane complex (zeolite membrane complex). Further, Japanese Patent Application Laid Open Gazette No. 2016-175063 (Document 1) discloses a method of recovering a performance of a DDR-type zeolite membrane used for separating a predetermined component from a mixed fluid. In this recovering method, the DDR-type zeolite membrane is heated up to a predetermined temperature not lower than 100° C. and not higher than 550° C. Japanese Patent Application Laid Open Gazette No. 2017-148741 (Document 2) discloses a method of recovering a performance of a used zeolite membrane complex by causing dry carbon dioxide gas to permeate the used zeolite membrane complex. WO 2020/136718 (Document 3) discloses a method of recovering a performance of a zeolite membrane by supplying carbon dioxide gas containing water to the zeolite membrane and then supplying a dry natural gas thereto.

Furthermore, in Japanese Patent Application Laid Open Gazette No. 2010-125394 (Document 4) and Japanese Patent Application Laid Open Gazette No. 2012-232310 (Document 5), disclosed is a system for cleaning a filter set in a cleaning chamber by causing a supercritical or subcritical cleaning fluid to flow into the cleaning chamber. The filter is an air filter or a liquid filter including a filter medium in which an adsorbent such as a granular zeolite or the like is interposed among a fiber such as a synthetic resin fiber or the like.

During the storage of the separation membrane complex after manufacture, the operation of attaching the separation membrane complex in a housing (casing), or the like, when the separation membrane is exposed to the air, the separation membrane adsorbs not only moisture in the air but also an organic compound such as a volatile organic compound (VOC) or the like, to easily block pores. For this reason, when the separation membrane complex itself is used for gas separation or the like by a separation apparatus, adequate membrane performance cannot be achieved. Particularly, when the separation membrane is a zeolite membrane, a lot of organic compounds are easily adsorbed to the membrane and the effect on the membrane performance is large.

Though it can be considered to recover the performance of the separation membrane by the method disclosed in Document 1, in this case, the separation membrane is sometimes deteriorated by heating. Further, in the case where the separation membrane is attached in the housing, some effects are sometimes produced on a member such as a packing or the like. Furthermore, by the methods disclosed in Documents 2 and 3, it is difficult to sufficiently remove the organic compound in the separation membrane. Further, the system disclosed in Documents 4 and 5 is used for the granular zeolite adsorbent, and these Documents do not disclose any cleaning fluid which should be used for a dense zeolite membrane.

### SUMMARY OF THE INVENTION

The present invention is intended for a processing method of a separation membrane complex, and it is an object of the present invention to appropriately recover a membrane performance of a separation membrane.

A first aspect of the present invention is a processing method of a separation membrane complex, and the processing method of a separation membrane complex includes a) preparing a separation membrane complex including a porous support and a separation membrane formed on the support and b) bringing a cleaning fluid composed of supercritical or subcritical carbon dioxide having a density of 600 to 1000 kg/m³ into contact with the separation membrane of the separation membrane complex, and in the processing method of a separation membrane complex, a gas permeance of a predetermined gas in the separation membrane after the operation b) is higher than that before the operation b).

According to the present invention, it is possible to remove an organic compound adsorbed to the separation membrane to thereby appropriately recover a membrane performance of the separation membrane.

A second aspect of the present invention is the processing method of a separation membrane complex of the first aspect, in which an average pore diameter of the separation membrane is not larger than 1 nm.

A third aspect of the present invention is the processing method of a separation membrane complex of the first or second aspect, in which the separation membrane is a zeolite membrane.

A fourth aspect of the present invention is the processing method of a separation membrane complex of any one of the first to third aspects, in which the predetermined gas is carbon dioxide.

A fifth aspect of the present invention is the processing method of a separation membrane complex of any one of the first to fourth aspects, in which a temperature of the separation membrane complex and the cleaning fluid is lower than 100° C. in the operation b).

A sixth aspect of the present invention is the processing method of a separation membrane complex of any one of the first to fifth aspects, in which the cleaning fluid comes into contact with both a face of the separation membrane on a side of the support and a face thereof on a side opposite to the support in the operation b).

A seventh aspect of the present invention is the processing method of a separation membrane complex of any one of the first to sixth aspects, in which the separation membrane complex is set in a housing, the housing is provided with a fluid supply port, a permeate fluid exhaust port, and a non-permeate fluid exhaust port, and the cleaning fluid is supplied into the housing from one port of the housing in the operation b).

An eighth aspect of the present invention is a processing apparatus for a separation membrane complex, and the processing apparatus for a separation membrane complex includes a complex housing part that holds therein a separation membrane complex including a porous support and a separation membrane formed on the support and a cleaning fluid supply part for performing a cleaning process in which a cleaning fluid composed of supercritical or subcritical carbon dioxide having a density of 600 to 1000 kg/m³ is brought into contact with the separation membrane of the separation membrane complex by supplying the cleaning fluid into the complex housing part, and in the processing apparatus for a separation membrane complex, a gas permeance of a predetermined gas in the separation membrane after the cleaning process is higher than that before the cleaning process.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a flowchart showing a flow of a processing for a separation membrane complex;

FIG. 2 is a cross-sectional view of the separation membrane complex;

FIG. 3 is a cross-sectional view enlargedly showing part of the separation membrane complex;

FIG. 4 is a cross-sectional view of a housing in which the separation membrane complex is attached;

FIG. 5 is a view showing a separation apparatus; and

FIG. 6 is a flowchart showing a flow for separating a mixed substance.

### DETAILED DESCRIPTION

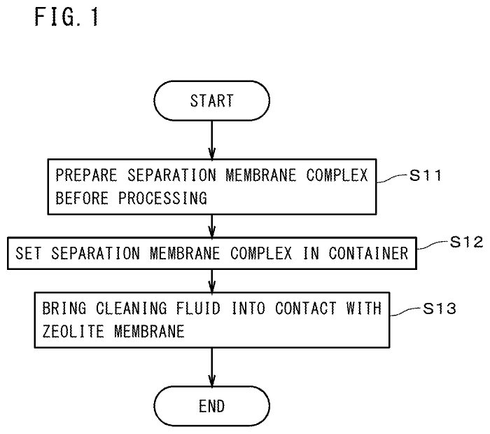

FIG. 1 is a flowchart showing a flow of a processing for a separation membrane complex. The processing shown in FIG. 1 is a processing in which an organic compound adsorbed in a separation membrane of the separation membrane complex is removed to thereby recover a membrane performance of the separation membrane.

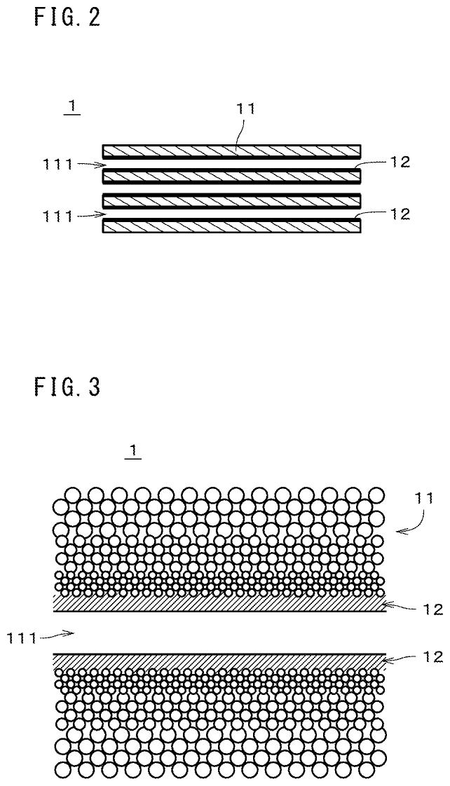

In the processing for a separation membrane complex, first, a separation membrane complex before the processing is prepared (Step S11). FIG. 2 is a cross-sectional view of the separation membrane complex 1. FIG. 3 is a cross-sectional view enlargedly showing part of the separation membrane complex 1. The separation membrane complex 1 includes a porous support 11 and a zeolite membrane 12 formed on the support 11. The zeolite membrane is at least obtained by forming zeolite on a surface of the support 11 in a membrane form and does not include a membrane obtained by simply dispersing zeolite particles in an organic membrane. Further, the zeolite membrane 12 may contain two or more types of zeolites which are different in the structure or the composition. In FIG. 2, the zeolite membrane 12 is represented by a thick line. In FIG. 3, the zeolite membrane 12 is hatched. Furthermore, in FIG. 3, the thickness of the zeolite membrane 12 is shown larger than the actual thickness.

The processing shown in FIG. 1 may be performed on the separation membrane complex 1 other than a zeolite membrane complex. Specifically, instead of the zeolite membrane 12, an inorganic membrane formed of an inorganic substance other than zeolite or a membrane other than the inorganic membrane may be formed on the support 11 as the separation membrane. As the separation membrane, other than the zeolite membrane, for example, a silica membrane, a carbon membrane, a metal organic framework (MOF) membrane, or the like can be used. Further, a separation membrane in which particles such as zeolite or the like are dispersed in an organic membrane may be used. In the following description, it is assumed that the separation membrane is the zeolite membrane 12.

The support 11 is a porous member that gas and liquid can permeate. In the exemplary case shown in FIG. 2, the support 11 is a monolith-type support having an integrally and continuously molded columnar main body with a plurality of through holes 111 each extending in a longitudinal direction (i.e., a left and right direction in FIG. 2). In the exemplary case shown in FIG. 2, the support 11 has a substantially columnar shape. A cross section perpendicular to the longitudinal direction of each of the through holes 111 (i.e., cells) is, for example, substantially circular. In FIG. 2, the diameter of each through hole 111 is larger than the actual diameter, and the number of through holes 111 is smaller than the actual number. The zeolite membrane 12 is formed over an inner surface of the through hole 111, covering substantially the entire inner surface of the through hole 111.

The length of the support 11 (i.e., the length in the left and right direction of FIG. 2) is, for example, 10 cm to 200 cm. The outer diameter of the support 11 is, for example, 0.5 cm to 30 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

As the material for the support 11, various materials (for example, ceramics or a metal) may be adopted only if the materials ensure chemical stability in the process step of forming the zeolite membrane 12 on the surface thereof. In the present preferred embodiment, the support 11 is formed of a ceramic sintered body. Examples of the ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite.

The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the zeolite membrane 12 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the zeolite membrane 12 is formed is, for example, 20% to 60%.

The support 11 has, for example, a multilayer structure in which a plurality of layers with different average pore diameters are layered in a thickness direction. The average pore diameter and the sintered particle diameter in a surface layer including the surface on which the zeolite membrane 12 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another.

The zeolite membrane 12 is a porous membrane having pores. The zeolite membrane 12 can be used as a separation membrane for separating a specific substance from a mixed substance in which a plurality of types of substances are mixed, by using a molecular sieving function. As compared with the specific substance, any one of the other substances is harder to permeate the zeolite membrane 12. In other words, the permeance of any other substance through the zeolite membrane 12 is smaller than that of the above specific substance.

The thickness of the zeolite membrane 12 is, for example, 0.05 μm to 30 μm, preferably 0.1 μm to 20 μm, and more preferably 0.5 μm to 10 μm. When the thickness of the zeolite membrane 12 is increased, the separation performance increases. When the thickness of the zeolite membrane 12 is reduced, the permeance increases. The surface roughness (Ra) of the zeolite membrane 12 is, for example, 5 μm or less, preferably 2 μm or less, more preferably 1 μm or less, and further preferably 0.5 μm or less.

The average pore diameter of the zeolite membrane 12 is, for example, 1 nm or less. The average pore diameter of the zeolite membrane 12 is preferably not smaller than 0.2 nm and not larger than 0.8 nm, more preferably not smaller than 0.3 nm and not larger than 0.5 nm, and further preferably not smaller than 0.3 nm and not larger than 0.4 nm. When the average pore diameter is larger than 1 nm, the separation performance is sometimes reduced. Further, when the average pore diameter is smaller than 0.2 nm, the permeance is sometimes reduced. The average pore diameter of the zeolite membrane 12 is smaller than that of the support 11 in the vicinity of the surface on which the zeolite membrane 12 is formed.

When the maximum number of membered rings of the zeolite forming the zeolite membrane 12 is n, an arithmetic average of the short diameter and the long diameter of an n-membered ring pore is defined as the average pore diameter. The n-membered ring pore refers to a pore in which the number of oxygen atoms in the part where the oxygen atoms and later-described T atoms are bonded to form a ring structure is n. When the zeolite has a plurality of types of n-membered ring pores having the same n, an arithmetic average of the short diameters and the long diameters of all types of n-membered ring pores is defined as the average pore diameter of the zeolite. Thus, the average pore diameter of the zeolite membrane is uniquely determined depending on the framework structure of the zeolite and can be obtained from values disclosed in “Database of Zeolite Structures” [online], internet <URL: http://www.iza-structure.org/databases/> of the International Zeolite Association.

There is no particular limitation on the type of the zeolite forming the zeolite membrane 12, but the zeolite membrane 12 may be formed of, for example, AEI-type, AEN-type, AFN-type, AFV-type, AFX-type, BEA-type, CHA-type, DDR-type, ERI-type, ETL-type, FAU-type (X-type, Y-type), GIS-type, LEV-type, LTA-type, MEL-type, MFI-type, MOR-type, PAU-type, RHO-type, SAT-type, SOD-type zeolite, or the like. The zeolite forming the zeolite membrane 12 may be one type or may be two or more types.

From the viewpoint of an increase in the permeance and an improvement in the separation performance of CO₂, it is preferable that the maximum number of membered rings of the zeolite should be 8 or less (for example, 6 or 8). The zeolite membrane 12 is formed of, for example, DDR-type zeolite. In other words, the zeolite membrane 12 is a zeolite membrane formed of the zeolite having a structure code of “DDR” which is designated by the International Zeolite Association. In this case, the unique pore diameter of the zeolite forming the zeolite membrane 12 is 0.36 nm×0.44 nm, and the average pore diameter is 0.40 nm.

The zeolite membrane 12 contains, for example, silicon (Si). The zeolite membrane 12 may contain, for example, any two or more of Si, aluminum (Al), and phosphorus (P). In this case, as the zeolite forming the zeolite membrane 12, zeolite in which atoms (T-atoms) located at the center of an oxygen tetrahedron (TO₄) constituting the zeolite include only Si or Si and Al, AlPO-type zeolite in which T-atoms include Al and P, SAPO-type zeolite in which T-atoms include Si, Al, and P, MAPSO-type zeolite in which T-atoms include magnesium (Mg), Si, Al, and P, ZnAPSO-type zeolite in which T-atoms include zinc (Zn), Si, Al, and P, or the like can be used. Some of the T-atoms may be replaced by other elements.

When the zeolite membrane 12 contains Si atoms and Al atoms, the ratio of Si/Al in the zeolite membrane 12 is, for example, not less than 1 and not more than 100,000. The Si/Al ratio is preferably 5 or more, more preferably 20 or more, and further preferably 100 or more. In short, the higher the ratio is, the better. By adjusting the mixing ratio of an Si source and an Al source in a later-described starting material solution, or the like, it is possible to adjust the Si/Al ratio in the zeolite membrane 12. The zeolite membrane 12 may contain an alkali metal. The alkali metal is, for example, sodium (Na) or potassium (K).

When the separation membrane is not a zeolite membrane, the pore diameter thereof can be obtained by using the nano-perm porometer or a well-known method such as a gas adsorption method or the like, and when the pore diameter has a distribution, the median diameter (D50) thereof is determined as the average pore diameter.

The separation membrane complex 1 before the processing may be prepared by a well-known method. As an exemplary method, first, DDR-type zeolite powder is attached to the support 11 as seed crystals. Subsequently, this support 11 is immersed in a starting material solution containing an Si source, a structure-directing agent, and the like. Then, the DDR-type zeolite is caused to grow from the seed crystals as a nucleus by the hydrothermal synthesis, to thereby form the DDR-type zeolite membranes 12 on the support 11. After that, a heat treatment is performed on the zeolite membrane 12, to thereby almost completely combustion-remove the structure-directing agent in the zeolite membrane 12, and this results in the formation of through micropores in the zeolite membrane 12. With the above processing, the above-described zeolite membrane complex 1 before the processing can be obtained. The zeolite membrane 12 may be any type other than the DDR-type one.

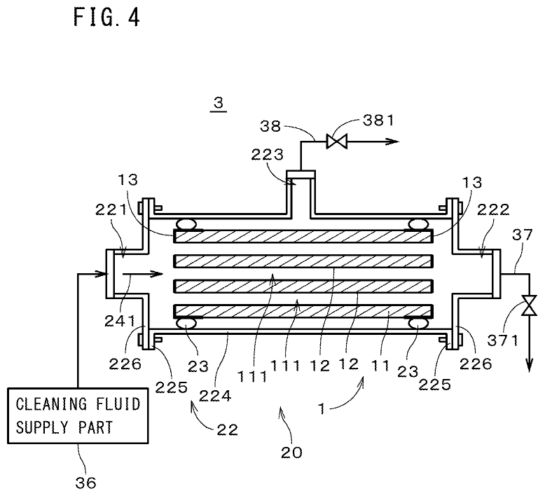

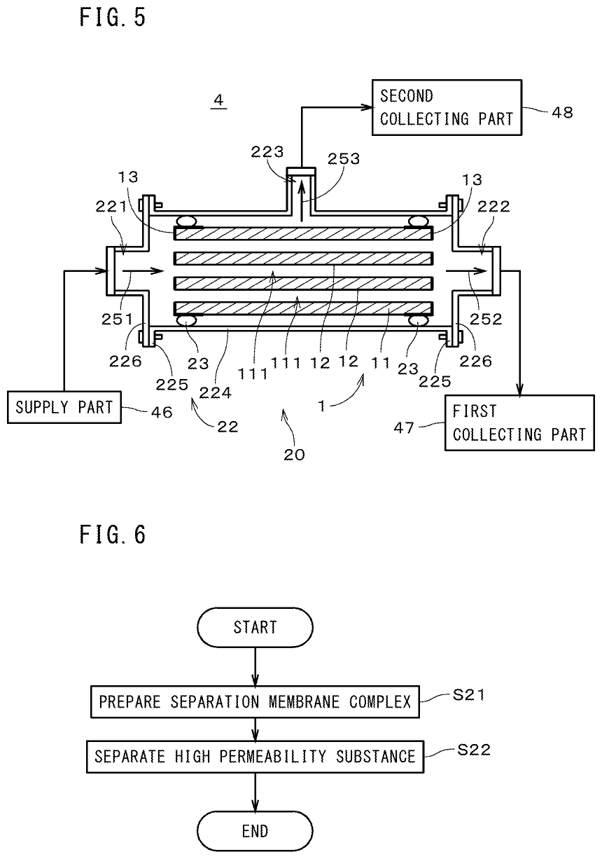

Subsequently, this separation membrane complex 1 is set in a predetermined container (Step S12). Herein, since the separation membrane complex 1 is used in a separation apparatus 4 (see FIG. 5) described later, the separation membrane complex 1 is attached into a housing 22 which is a housing container in the separation apparatus 4. FIG. 4 is a cross-sectional view of the housing 22 in which the separation membrane complex 1 is attached. In FIG. 4, a cleaning fluid supply part 36 described later is shown by a block and a first exhaust pipe 37 and a second exhaust pipe 38 are also shown.

In a case where the separation membrane complex 1 is attached in the housing 22, as an advance preparation (for example, before forming the zeolite membrane 12 on the support 11), sealing parts 13 are formed at both end portions of the support 11, respectively, in the longitudinal direction. The sealing parts 13 are members which cover and seal both end surfaces in the longitudinal direction of the support 11 and outer surfaces in the vicinity of the end surfaces. The sealing parts 13 prevent inflow and outflow of a gas from both the end surfaces of the support 11. The sealing part 13 is formed of, for example, glass, a resin, or a metal. The material and the shape of the sealing part 13 may be changed as appropriate. Furthermore, both ends of each through hole 111 in the longitudinal direction are not covered with the sealing parts 13, and therefore, the inflow and outflow of gas to/from the through hole 111 from/to both the ends thereof can be made.

There is no particular limitation on the shape of the housing 22 but is, for example, a tubular member having a substantially cylindrical shape. The housing 22 is formed of, for example, stainless steel or carbon steel. The longitudinal direction of the housing 22 is substantially in parallel to the longitudinal direction of the separation membrane complex 1. A fluid supply port 221 is provided at an end portion on one side in the longitudinal direction of the housing 22 (i.e., an end portion on the left side in FIG. 4), and a non-permeate fluid exhaust port 222 is provided at another end portion on the other side. A permeate fluid exhaust port 223 is provided on a side surface of the housing 22. An internal space of the housing 22 is a sealed space that is isolated from the space around the housing 22.

In the exemplary case shown in FIG. 4, the housing 22 includes a housing body 224 and two cover parts 226. The housing body 224 is a substantially cylindrical member having openings at both end portions in the longitudinal direction. The housing body 224 is provided with two flange parts 225. The two flange parts 225 are substantially annular disk-like portions extending radially outward from the housing body 224 around the above-described two openings of the housing body 224, respectively. The housing body 224 and the two flange parts 225 are connected members. The two cover parts 226 are fixed to the two flange parts 225 by being bolted or the like while covering the above-described two openings of the housing body 224, respectively. The two openings of the housing body 224 are thereby sealed hermetically. The above-described fluid supply port 221 is provided in the cover part 226 on the left side in FIG. 4. The non-permeate fluid exhaust port 222 is provided in the cover part 226 on the right side in FIG. 4. The permeate fluid exhaust port 223 is provided at the substantially center of the housing body 224 in the longitudinal direction.

The separation membrane complex 1 is fixed to the housing 22 with two sealing members 23 interposed therebetween. The two sealing members 23 are arranged around the entire circumference between an outer surface of the separation membrane complex 1 and an inner surface of the housing 22 (the housing body 224) in the vicinity of both end portions of the separation membrane complex 1 in the longitudinal direction. Each of the sealing members 23 is a substantially annular member formed of a material that the gas cannot permeate. The sealing member 23 is, for example, an O-ring formed of a flexible resin. The sealing members 23 come into close contact with the outer surface of the separation membrane complex 1 and the inner surface of the housing 22 around the entire circumferences thereof. In the exemplary case of FIG. 4, the sealing members 23 come into close contact with outer surfaces of the sealing parts 13 and indirectly come into close contact with the outer surface of the separation membrane complex 1 with the sealing parts 13 interposed therebetween. The portions between the sealing members 23 and the outer surface of the separation membrane complex 1 and between the sealing members 23 and the inner surface of the housing 22 are sealed, and it is thereby mostly or completely impossible for the gas to pass through the portions.

In FIG. 4, the separation membrane complex 1, the housing 22, and the two sealing members 23 constitute a separation membrane module 20. The separation membrane module 20 may include any other constituent element. As described later, the separation membrane module 20 is attached to the separation apparatus 4 and used. During the storage of the separation membrane complex 1 after manufacture, the operation of attaching the separation membrane complex 1 in the housing 22, or the like, ordinarily the zeolite membrane 12 is exposed to the air. At that time, the zeolite membrane 12 adsorbs not only moisture in the air but also an organic compound such as a volatile organic compound (VOC) or the like, and the pores are blocked by the organic compound. Also in the separation membrane module 20 shown in FIG. 4, the zeolite membrane 12 adsorbs the organic compound such as the VOC or the like. If the separation membrane module 20 is used as-is in the separation apparatus 4, adequate membrane performance cannot be achieved.

Subsequently, the cleaning fluid supply part 36 is connected to the fluid supply port 221 of the housing 22. The cleaning fluid supply part 36 includes, for example, a pump for supplying a cleaning fluid into the housing 22. The pump includes a pressure regulating part for regulating the pressure of the cleaning fluid to be supplied to the housing 22. Further, the first exhaust pipe 37 is connected to the non-permeate fluid exhaust port 222 of the housing 22 and the second exhaust pipe 38 is connected to the permeate fluid exhaust port 223 thereof. The first exhaust pipe 37 is provided with a valve 371 and the second exhaust pipe 38 is provided with a valve 381. As described later, a cleaning process for the separation membrane complex 1 set in the housing 22 is performed by using the cleaning fluid supplied into the housing 22 from the cleaning fluid supply part 36. Therefore, it can be said that the cleaning fluid supply part 36 and the housing 22 which is a complex housing part constitute a processing apparatus 3 for the separation membrane complex 1. The processing apparatus 3 may include any other constituent part.

Herein, the cleaning fluid is a fluid composed of supercritical or subcritical carbon dioxide (CO₂). Carbon dioxide has a small molecular diameter and can be easily diffused into the pores of the zeolite membrane 12. The density of carbon dioxide in the cleaning fluid is 600 to 1000 kg/m³. Since carbon dioxide having this density range has a value of solubility parameter close to that of the organic compound such as the VOC or the like, the carbon dioxide has good miscibility (affinity) with the organic compound. The cleaning fluid may contain any substance (e.g., nitrogen or the like) other than CO₂ and in this case, the density as CO₂ has only to be 600 to 1000 kg/m³.

After that, while the valve 371 of the first exhaust pipe 37 and the valve 381 of the second exhaust pipe 38 are closed, the cleaning fluid supply part 36 supplies the cleaning fluid into the internal space of the housing 22 through the fluid supply port 221. The cleaning fluid fills the vicinity of the fluid supply port 221 in the internal space of the housing 22 and is fed from the left end of the separation membrane complex 1 in this figure into each through hole 111 of the support 11 as indicated by an arrow 241. The cleaning fluid thereby comes into contact with a surface (i.e., a face opposite to the support 11) of the zeolite membrane 12 formed on the inner surface of the through hole 111 (Step S13).

Part of the cleaning fluid is diffused into the pores of the zeolite membrane 12. The cleaning fluid passing through the zeolite membrane 12 and the support 11 is exhausted from an outer surface of the support 11. The cleaning fluid thereby fills a space between the outer surface of the support 11 and the inner surface of the housing body 224 and a space of the permeate fluid exhaust port 223. Further, the cleaning fluid passing through the zeolite membrane 12 may become gas or liquid. The rest of the cleaning fluid fed into the through hole 111 does not pass through the zeolite membrane 12 and is exhausted from the right end of the separation membrane complex 1 in this figure. The cleaning fluid also thereby fills the vicinity of the non-permeate fluid exhaust port 222 in the internal space of the housing 22.

In the processing apparatus 3, the cleaning fluid in the housing 22 is held for a predetermined time at a constant temperature and a constant pressure. As described earlier, since the miscibility between the organic compound in the pores of the zeolite membrane 12 and the cleaning fluid is high, the organic compound is dissolved in the cleaning fluid. The cleaning fluid in the pores of the zeolite membrane 12 is exhausted to the outside as described later. Therefore, a process of bringing the cleaning fluid into contact with the zeolite membrane 12 is the cleaning process for removing the organic compound in the zeolite membrane 12. At that time, when the ratio of Si/Al (molar ratio) in the zeolite membrane 12 is five or more, since the affinity between the zeolite membrane 12 and the cleaning fluid becomes higher, the removal of the organic compound is accelerated. Further, there may be a configuration where the cleaning fluid supply part 36 supplies liquefied carbon dioxide (CO₂) into the housing 22 and then pressurizes or heats the CO₂ in the housing 22, to be brought into the supercritical or subcritical state.

So far as the density of the cleaning fluid in the housing 22 is 600 to 1000 kg/m³, there is no particular limitation on the temperature and the pressure of the cleaning fluid. From the viewpoint of suppressing deterioration of the zeolite membrane 12 and the sealing members 23 due to the cleaning process, the temperature of the cleaning fluid in the housing 22 is preferably lower than 100° C., more preferably lower than 80° C., and further preferably lower than 60° C. So far as the above-described density range of the cleaning fluid is satisfied, the lower limit of the temperature of the cleaning fluid in the housing 22 is not particularly limited but is, for example, 0° C. Further, from the viewpoint of avoiding an increase in the manufacturing cost of the housing 22, it is preferable that the pressure of the cleaning fluid in the housing 22 should not be excessively high. The pressure of the cleaning fluid in the housing 22 is, for example, not higher than 100 MPa, preferably not higher than 60 MPa, and more preferably not higher than 40 MPa. So far as the above-described density range of the cleaning fluid is satisfied, the lower limit of the pressure of the cleaning fluid in the housing 22 is not particularly limited but is, for example, 5 MPa. The time for the cleaning process is, for example, 1 to 100 hours.

There may be a configuration where the cleaning fluid supply part 36 is connected to the non-permeate fluid exhaust port 222 or the permeate fluid exhaust port 223 in the housing 22 and the cleaning fluid is supplied into the housing 22. Further, the cleaning fluid may be supplied into the housing 22 from both the fluid supply port 221 and the permeate fluid exhaust port 223. In this case, the cleaning fluid not passing through the zeolite membrane 12 yet can be brought into contact with both a face of the zeolite membrane 12 on the side of the support 11 and another face thereof on the side opposite to the support 11, and removal of the organic compound can be more effectively performed. In the housing 22, the cleaning fluid is supplied thereinto from at least one port.

When the cleaning process is completed, by opening the valve 371 of the first exhaust pipe 37 and the valve 381 of the second exhaust pipe 38 shown in FIG. 4, the pressure of the housing 22 is released. The cleaning fluid in which the organic compound is dissolved, which exists in the pores of the zeolite membrane 12, is also exhausted to the outside. After that, by detaching the cleaning fluid supply part 36, the first exhaust pipe 37, and the second exhaust pipe 38 from the housing 22, the processing shown in FIG. 1 for the separation membrane complex 1 is completed. Further, the cleaning fluid supply part 36, the first exhaust pipe 37, and the second exhaust pipe 38 may not be detached from the housing 22. Furthermore, it is preferable that a cap member for preventing outside air from entering the housing 22 should be attached to each of the fluid supply port 221, the non-permeate fluid exhaust port 222, and permeate fluid exhaust port 223 of the housing 22.

Herein, when the gas permeance of a predetermined gas in the separation membrane complex 1 immediately before the cleaning process in Step S13 (i.e., the separation membrane complex 1 immediately after being attached in the housing 22) and the gas permeance of the gas in the separation membrane complex 1 immediately after the cleaning process are measured, the gas permeance immediately after the cleaning process is larger than that immediately before the cleaning process. The type of predetermined gas used for the measurement of the gas permeance is not particularly limited only if the gas can permeate the zeolite membrane 12 but is, for example, a gas that has a molecule having a kinetic diameter smaller than the average pore diameter of the zeolite membrane 12, and preferably He, H₂, H₂O, N₂, O₂, or CO₂ and more preferably CO₂. Since CO₂ has a small molecular diameter and can be easily diffused into the pores of the zeolite membrane 12, by using CO₂ as the predetermined gas, it is possible to more accurately evaluate the degree of closing the pores of the zeolite membrane 12. In the present preferred embodiment, CO₂ is used as the predetermined gas.

The ratio of the CO₂ permeance immediately after the cleaning process to that immediately before the cleaning process (i.e., (CO₂ permeance immediately after cleaning process)/(CO₂ permeance immediately before cleaning process), and hereinafter, referred to as a “CO₂ recovery ratio”) is, for example, not less than 3, preferably not less than 4, and more preferably not less than 5. The upper limit of the CO₂ recovery ratio is not particularly limited. Thus, it is thought that since the CO₂ permeance of the separation membrane complex 1 is increased by the cleaning process, the organic compound adsorbed to the zeolite membrane 12 is appropriately removed. Further, the processing method shown in FIG. 1 may be performed on the separation membrane complex 1 after being used in the separation apparatus 4.

Next, with reference to FIGS. 5 and 6, separation of a mixed substance by using the separation membrane complex 1 will be described. FIG. 5 is a view showing the separation apparatus 4. FIG. 6 is a flowchart showing a flow for separating a mixed substance by the separation apparatus 4.

In the separation apparatus 4, a mixed substance containing a plurality of types of fluids (i.e., gases or liquids) is supplied to the separation membrane complex 1, and a substance with high permeability in the mixed substance is caused to permeate the separation membrane complex 1, to be thereby separated from the mixed substance. Separation in the separation apparatus 4 may be performed, for example, in order to extract a substance with high permeability from a mixed substance, or in order to concentrate a substance with low permeability.

The mixed substance (i.e., mixed fluid) may be a mixed gas containing a plurality of types of gases, may be a mixed liquid containing a plurality of types of liquids, or may be a gas-liquid two-phase fluid containing both a gas and a liquid.

The mixed substance contains at least one type of, for example, hydrogen (H₂), helium (He), nitrogen (N₂), oxygen (O₂), water (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde.

The nitrogen oxide is a compound of nitrogen and oxygen. The above-described nitrogen oxide is, for example, a gas called NOx such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SO_{X} such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S=SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH(CH₃)₃), 1-butene (CH₂═CHCH₂CH₃), 2-butene (CH₃CH═CHCH₃), or isobutene (CH₂═C(CH₃)₂).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

In the following description, it is assumed that the mixed substance separated by the separation apparatus 4 is a mixed gas containing a plurality of types of gases.

The separation apparatus 4 includes the separation membrane module 20, a supply part 46, a first collecting part 47, and a second collecting part 48. As described earlier, the separation membrane module 20 includes the separation membrane complex 1, the housing 22, and the two sealing members 23. The separation membrane complex 1 and the sealing members 23 are set in the housing 22. In the separation membrane complex 1, the organic compound in the zeolite membrane 12 has been removed by the processing shown in FIG. 1. The supply part 46, the first collecting part 47, and the second collecting part 48 are arranged outside the housing 22 and connected to the housing 22. Specifically, the supply part 46 is connected to the fluid supply port 221. The first collecting part 47 is connected to the non-permeate fluid exhaust port 222. The second collecting part 48 is connected to the permeate fluid exhaust port 223.

The supply part 46 supplies the mixed gas into the internal space of the housing 22 through the fluid supply port 221. The supply part 46 is, for example, a blower or a pump for pumping the mixed gas toward the housing 22. The blower or the pump includes a pressure regulating part for regulating the pressure of the mixed gas to be supplied to the housing 22. The first collecting part 47 and the second collecting part 48 are each, for example, a storage tank for storing the gas led out from the housing 22 or a blower or a pump for transporting the gas.

When separation of the mixed gas is performed, the above-described separation apparatus 4 is prepared and the separation membrane complex 1 is thereby prepared (Step S21). Subsequently, the supply part 46 supplies a mixed gas containing a plurality of types of gases with different permeabilities for the zeolite membrane 12 into the internal space of the housing 22. For example, the main component of the mixed gas includes CO₂ and CH₄. The mixed gas may contain any gas other than CO₂ or CH₄. The pressure (i.e., feed pressure) of the mixed gas to be supplied into the internal space of the housing 22 from the supply part 46 is, for example, 0.1 MPa to 20.0 MPa. The temperature for separation of the mixed gas is, for example, 10° C. to 150° C.

The mixed gas supplied from the supply part 46 into the housing 22 is fed from the left end of the separation membrane complex 1 in this figure into the inside of each through hole 111 of the support 11 as indicated by an arrow 251. Gas with high permeability (which is, for example, CO₂, and hereinafter is referred to as a “high permeability substance”) in the mixed gas permeates the zeolite membrane 12 formed on the inner surface of each through hole 111 and the support 11, and is led out from the outer surface of the support 11. The high permeability substance is thereby separated from gas with low permeability (which is, for example, CH₄, and hereinafter is referred to as a “low permeability substance”) in the mixed gas (Step S22). The gas led out from the outer surface of the support 11 (hereinafter, referred to as a “permeate substance”) is collected by the second collecting part 48 through the permeate fluid exhaust port 223 as indicated by an arrow 253. The pressure of the gas to be collected by the second collecting part 48 through the permeate fluid exhaust port 223 (i.e., permeate pressure) is, for example, about 1 atmospheric pressure (0.101 MPa).

Further, in the mixed gas, a gas other than the gas which has permeated the zeolite membrane 12 and the support 11 (hereinafter, referred to as a “non-permeate substance”) passes through each through hole 111 of the support 11 from the left side to the right side in this figure and is collected by the first collecting part 47 through the non-permeate fluid exhaust port 222 as indicated by an arrow 252. The pressure of the gas to be collected by the first collecting part 47 through the non-permeate fluid exhaust port 222 is, for example, substantially the same as the feed pressure. The non-permeate substance may include a high permeability substance that has not permeated the zeolite membrane 12, as well as the above-described low permeability substance.

Next, Examples 1 to 5 and Comparative Examples 1 to 3 of the processing for the separation membrane complex will be described.

### Example 1

The DDR-type zeolite membrane is synthesized on a porous alumina support by the hydrothermal synthesis and the structure-directing agent is removed by heating, to thereby obtain a separation membrane complex. The separation membrane complex is held at 25° C. in the atmosphere for one week.

CO₂ permeance is determined from the amount of CO₂ gas permeating the zeolite membrane under the conditions that CO₂ gas is supplied to the separation membrane complex at 0.3 MPa and the pressure on a permeate side is set at 0.1 MPa. After that, the separation membrane complex is put into a pressure vessel and liquefied CO₂ is injected thereinto, and a process (cleaning process) in which the separation membrane complex is held at 40° C. and 9.7 MPa for 50 hours is performed. The density of CO₂ at that time is 600 kg/m³.

After releasing the pressure from the pressure vessel, the separation membrane complex is taken out therefrom and the CO₂ permeance is determined by the same method as the preceding one. When the CO₂ recovery ratio is obtained from (CO₂ permeance after processing)/(CO₂ permeance before processing), the CO₂ recovery ratio is 7.5.

### Example 2

The cleaning process is performed under the same condition as that in Example 1 except that the separation membrane complex is held at 40° C. and 25 MPa. The density of CO₂ at that time is 880 kg/m³. The CO₂ recovery ratio in Example 2 is 7.7.

### Example 3

The cleaning process is performed under the same condition as that in Example 1 except that the separation membrane complex is held at 10° C. and 25 MPa. The density of CO₂ at that time is 1000 kg/m³. The CO₂ recovery ratio in Example 3 is 6.8.

### Example 4

The cleaning process is performed under the same condition as that in Example 1 except that a CHA-type zeolite membrane is used, instead of the DDR-type zeolite membrane. The CHA-type zeolite membrane is produced with reference to Comparative Example 2 of Japanese Patent Application Laid Open Gazette No. 2014-198308, which is incorporated herein by reference. The CO₂ recovery ratio in Example 4 is 10.3.

### Example 5

The cleaning process is performed under the same condition as that in Example 1 except that a carbon membrane is used, instead of the DDR-type zeolite membrane. The carbon membrane is produced with reference to Example 3 of Japanese Patent Application Laid Open Gazette No. 2011-201753, which is incorporated herein by reference. The CO₂ recovery ratio in Example 5 is 5.1.

### Comparative Example 1

The cleaning process is performed under the same condition as that in Example 1 except that the separation membrane complex is held at 40° C. and 1 MPa. The density of CO₂ at that time is 18 kg/m³, and CO₂ in the pressure vessel is neither in the supercritical state nor in the subcritical state. The CO₂ recovery ratio in Comparative Example 1 is 2.4.

### Comparative Example 2

The cleaning process is performed under the same condition as that in Example 4 except that the separation membrane complex is held at 40° C. and 1 MPa. The density of CO₂ at that time is 18 kg/m³, and CO₂ in the pressure vessel is neither in the supercritical state nor in the subcritical state. The CO₂ recovery ratio in Comparative Example 2 is 1.5.

### Comparative Example 3

The cleaning process is performed under the same condition as that in Example 5 except that the separation membrane complex is held at 40° C. and 1 MPa. The density of CO₂ at that time is 18 kg/m³, and CO₂ in the pressure vessel is neither in the supercritical state nor in the subcritical state. The CO₂ recovery ratio in Comparative Example 3 is 1.2.

In Examples 1 to 5, high CO₂ recovery ratio can be obtained, and it can be thought that the organic compound adsorbed to the separation membrane is effectively removed. On the other hand, in each of Comparative Examples 1 to 3, the CO₂ recovery ratio becomes significantly lower than that in each of Examples 1 to 5. Therefore, it can be said that in CO₂ not having a density of 600 to 1000 kg/m³, the organic compound adsorbed to the separation membrane cannot be effectively removed. Further, in Examples 1 to 4 where the separation membrane is a zeolite membrane, the CO₂ recovery ratio becomes higher than that in Example 5 where the separation membrane is a carbon membrane. Therefore, it can be said that the processing using CO₂ having a density of 600 to 1000 kg/m³ is more suitable for the zeolite membrane.

As described above, the processing method of the separation membrane complex 1 includes a step of preparing the separation membrane complex 1 including the porous support 11 and the separation membrane (the zeolite membrane 12 in the above-described exemplary processing) formed on the support 11 (Step S11) and a step of bringing the cleaning fluid composed of supercritical or subcritical CO₂ having a density of 600 to 1000 kg/m³ into contact with the separation membrane (Step S13). Since the CO₂ in the cleaning fluid is easily diffused into the pores of the separation membrane and the miscibility between the organic compound adsorbed to the separation membrane and the cleaning fluid is high, the organic compound can be effectively removed. The gas permeance of the predetermined gas in the separation membrane after the cleaning process in Step S13 thereby becomes significantly larger than that before the cleaning process, and it is possible to appropriately recover the membrane performance of the separation membrane.

Preferably, the separation membrane complex 1 is set in the housing 22 and the housing 22 is provided with the fluid supply port 221, the permeate fluid exhaust port 223, and the non-permeate fluid exhaust port 222. Then, in the cleaning process of Step S13, the cleaning fluid is supplied into the housing 22 from one port of the housing 22. It thereby becomes possible to easily perform the cleaning process.

Preferably, the average pore diameter of the separation membrane is not larger than 1 nm. In the present processing method, the organic compound adsorbed to the separation membrane having such a small average pore diameter can be also appropriately removed. Preferably, in the cleaning process, the temperature of the separation membrane complex 1 and the cleaning fluid is lower than 100° C. It is thereby possible to suppress deterioration of the separation membrane in the cleaning process. Further, when the cleaning process is performed on the separation membrane complex 1 set in the housing 22, it is possible to suppress deterioration of the sealing members 23.

The processing apparatus 3 for the separation membrane complex 1 includes the complex housing part (the housing 22 in the exemplary case of FIG. 4) that holds therein the separation membrane complex 1, and the cleaning fluid supply part 36 for performing the cleaning process in which the cleaning fluid composed of supercritical or subcritical CO₂ having a density of 600 to 1000 kg/m³ is brought into contact with the separation membrane of the separation membrane complex 1 by supplying the cleaning fluid into the complex housing part. As described earlier, since it is possible to effectively remove the organic compound adsorbed to the separation membrane by the cleaning process, the gas permeance of the predetermined gas in the separation membrane after the cleaning process becomes significantly larger than that before the cleaning process. Thus, in the processing apparatus 3, it is possible to appropriately recover the membrane performance of the separation membrane.

In the above-described processing method and processing apparatus 3 for a separation membrane complex 1, various modifications can be made.

Depending on the type of separation membrane formed in the separation membrane complex 1, the average pore diameter of the separation membrane may be larger than 1 nm. Further, in the cleaning process of Step S13, the temperature of the separation membrane complex 1 and the cleaning fluid may be not lower than 100° C.

The separation membrane complex 1 on which the processing method shown in FIG. 1 is performed do not necessarily need to be set in the housing 22. There may be a case, for example, where the separation membrane complex 1 is placed in a predetermined container and the cleaning fluid fills the inside of the container in the cleaning process. In this case, this container is the complex housing part of the processing apparatus 3. In this container, the cleaning fluid not passing through the zeolite membrane 12 yet can be brought into contact with both the face of the zeolite membrane 12 on the side of the support 11 and the face thereof on the side opposite to the support 11, and removal of the organic compound can be more effectively performed.

The separation membrane complex 1 may further include a function layer or a protective layer laminated on the zeolite membrane 12, additionally to the support 11 and the zeolite membrane 12. Such a function layer or a protective layer may be an inorganic membrane such as the zeolite membrane, a silica membrane, a carbon membrane, or the like or an organic membrane such as a polyimide membrane, a silicone membrane, or the like. Further, a substance that is easy to adsorb specific molecules such as CO₂ or the like may be added to the function layer or the protective layer laminated on the zeolite membrane 12.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The processing method and processing apparatus for a separation membrane complex of the present invention can be used for a separation membrane complex used in various fields.

### REFERENCE SIGNS LIST

1 Separation membrane complex
3 Processing apparatus
11 Support
12 Zeolite membrane
22 Housing
36 Cleaning fluid supply part
221 Fluid supply port
222 Non-permeate fluid exhaust port
223 Permeate fluid exhaust port
S11 to S13, S21, S22 Step

1. A processing method of a separation membrane complex, comprising:
a) preparing a separation membrane complex comprising a porous support and a separation membrane formed on said support, wherein an average pore diameter of said separation membrane is not larger than 1 nm; and
b) bringing a cleaning fluid composed of supercritical or subcritical carbon dioxide having a density of 600 to 1000 kg/m³ into contact with said separation membrane of said separation membrane complex,
wherein a gas permeance of a predetermined gas in said separation membrane after said operation b) is higher than that before said operation b).

2. The processing method of a separation membrane complex according to claim 1, wherein
said separation membrane is a zeolite membrane.

3. The processing method of a separation membrane complex according to claim 1, wherein
said predetermined gas is carbon dioxide.

4. The processing method of a separation membrane complex according to claim 1, wherein
a temperature of said separation membrane complex and said cleaning fluid is lower than 100° C. in said operation b).

5. The processing method of a separation membrane complex according to claim 1, wherein
said cleaning fluid comes into contact with both a face of said separation membrane on a side of said support and a face thereof on a side opposite to said support in said operation b).

6. The processing method of a separation membrane complex according to claim 1, wherein
said separation membrane complex is set in a housing,
said housing is provided with a fluid supply port, a permeate fluid exhaust port, and a non-permeate fluid exhaust port, and
said cleaning fluid is supplied into said housing from one port of said housing in said operation b).

7. A processing apparatus for a separation membrane complex, comprising:
a complex housing part that holds therein a separation membrane complex comprising a porous support and a separation membrane formed on said support, wherein an average pore diameter of said separation membrane is not larger than 1 nm; and
a cleaning fluid supply part for performing a cleaning process in which a cleaning fluid composed of supercritical or subcritical carbon dioxide having a density of 600 to 1000 kg/m³ is brought into contact with said separation membrane of said separation membrane complex by supplying said cleaning fluid into said complex housing part,
wherein a gas permeance of a predetermined gas in said separation membrane after said cleaning process is higher than that before said cleaning process.
